(19) United States
(12) Patent Application Publication
(10) Pub. No.: US 2005/0024197 A1
(43) Pub. Date: Feb. 3, 2005

(54) Auxiliary directional light device for an automobile

(76) Inventor: Chung-Yin Cheng, Chang-Hua Hsien (TW)

Correspondence Address: JOSEPH G CURATOLO, ESQ.;CURATOLO SIDOTI CO. LPA, 24500 CENTER RIDGE ROAD, SUITE 280, CLEVELAND, OH, 44145, US

(21) Appl. No.: 10/681,510

(22) Filed: Oct. 8, 2003

(30) Foreign Application Priority Data
Aug. 1, 2003 (TW) 092214057

(51) Int. Cl. B60Q 1/34

(52) U.S. Cl. 340/475

(57) ABSTRACT

An auxiliary directional light device includes left and right auxiliary signal lights that are to be mounted respectively on upper left and right corner portions of a windshield of an automobile, and that are to be operated in synchronization with a main directional lighting unit of the automobile. The construction as such prevents light emitted by left and right headlights of the automobile from obscuring light emitted by the left and right auxiliary signal lights.

### CROSS-REFERENCE TO RELATED APPLICATION

This application claims priority of Taiwanese application no. 092214057, filed on Aug. 1, 2003.

### BACKGROUND OF THE INVENTION

1. Field of the Invention

The invention relates to a light device, more particularly to an auxiliary directional light device for an automobile.

2. Description of the Related Art

An automobile includes an automobile body, left and right headlights mounted respectively on left and right front end portions of the automobile body, front left and right main signal lights mounted respectively on the left and right front end portions of the automobile body, and rear left and right main signal lights mounted respectively on left and right rear end portions of the automobile body. Each of the front left and right main signal lights is generally disposed at a level below a respective one of the left and right headlights.

Although the main signal lights achieve their intended purpose, since the light emitted by the left and right headlights has a brightness level that is relatively higher than that of light emitted by the front left and right main signal lights, the light emitted by the latter is easily obscured by the light emitted by the former. Furthermore, since the main signal lights are disposed relatively low, they can be easily blocked by nearby automobiles.

### SUMMARY OF THE INVENTION

Therefore, the object of the present invention is to provide an auxiliary directional light device so as to overcome the aforesaid drawbacks of the prior art.

According to the present invention, there is provided an auxiliary directional light device for an automobile that has an automobile body mounted with a main directional lighting unit, and a directional lighting controller for controlling operation of the main directional lighting unit. The auxiliary directional light device comprises left and right auxiliary signal lights that are adapted to be mounted on the automobile body at a level above the main directional lighting unit and that are adapted to be coupled electrically to the directional lighting controller such that the auxiliary signal lights operate in synchronization with the main directional lighting unit.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view showing the first preferred embodiment of an auxiliary directional light device when mounted on a front windshield of an automobile according to the present invention;

FIG. 2 is an exploded perspective view of the first preferred embodiment;

FIG. 3 is a perspective view to illustrate an alternative embodiment of the auxiliary directional light device;

FIG. 4 is a perspective view showing the first preferred embodiment when mounted on a rear windshield of an automobile according to the present invention;

FIG. 5 is a perspective view showing the first preferred embodiment when mounted on front and rear windshields of an automobile according to the present invention; and

FIG. 6 is a perspective view showing the second preferred embodiment of an auxiliary directional light device incorporated in a rearview mirror of an automobile according to the present invention.

### DETAILED DESCRIPTION OF THE PREFERRED EMBODIMENTS

Before the present invention is described in greater detail, it should be noted that like elements are denoted by the same reference numerals throughout the disclosure.

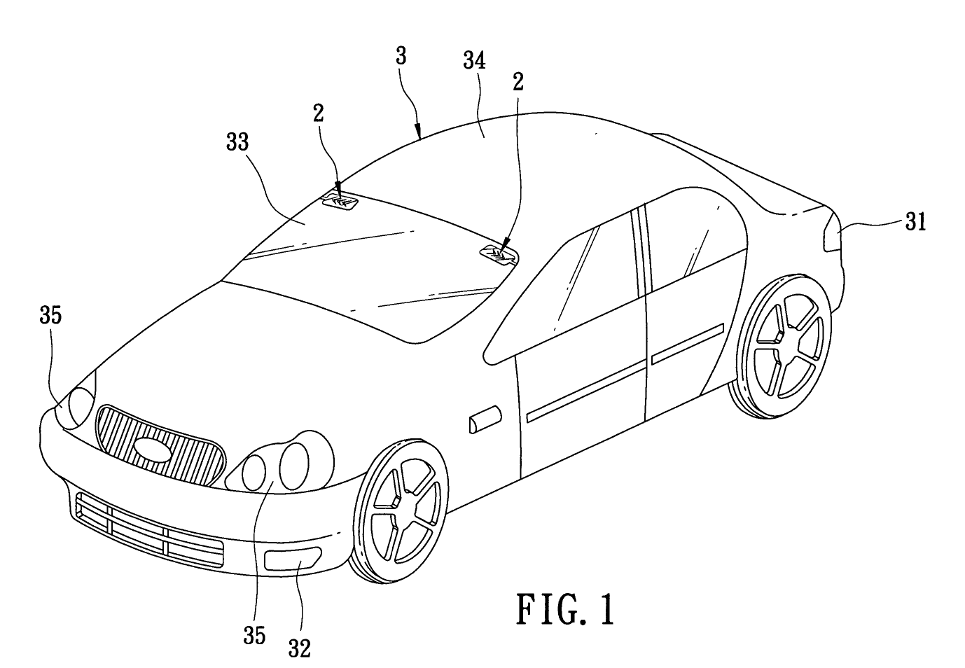

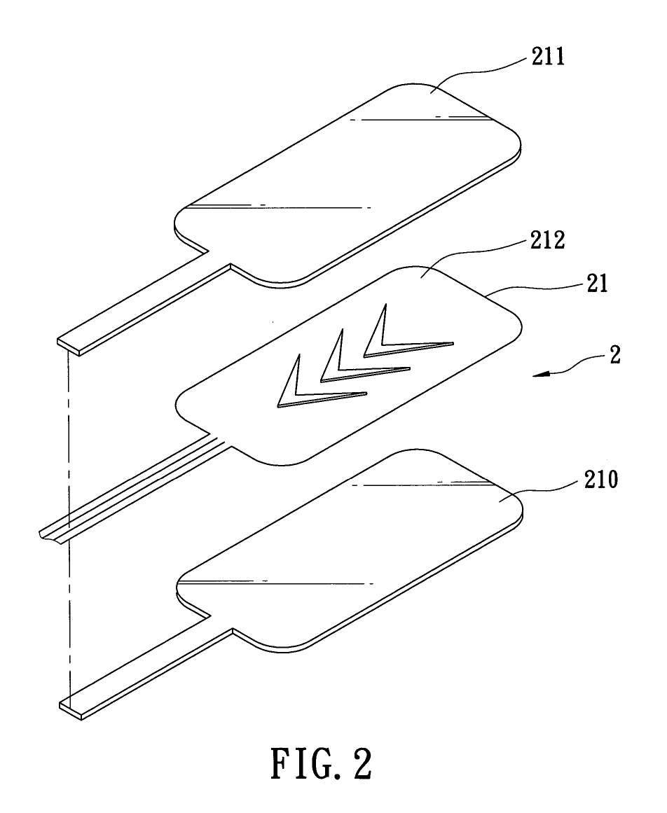

Referring to FIGS. 1 and 2, the first preferred embodiment of an auxiliary directional light device for an automobile 3 according to the present invention is shown to include a pair of left and right auxiliary signal lights 2.

The automobile 3 includes an automobile body 34, a main directional lighting unit, and a directional lighting controller (not shown). The automobile body 34 includes a front windshield 33 and a rear windshield (not visible). The main directional lighting unit includes front left and right main signal lights 32 (only the front left main signal light 32 is visible in FIG. 1) mounted respectively on left and right front end portions of the automobile body 34, and rear left and right main signal lights 31 (only the rear left main signal light 31 is visible in FIG. 1) mounted respectively on left and right rear end portions of the automobile body 34. The directional lighting controller is operable so as to control operation of the front and rear left and right main signal lights 32, 31 of the main directional lighting unit. The automobile 3 further includes left and right headlights 35 mounted respectively on the left and right front end portions of the automobile body 34, and disposed respectively at a level above the front left and right main signal lights 32.

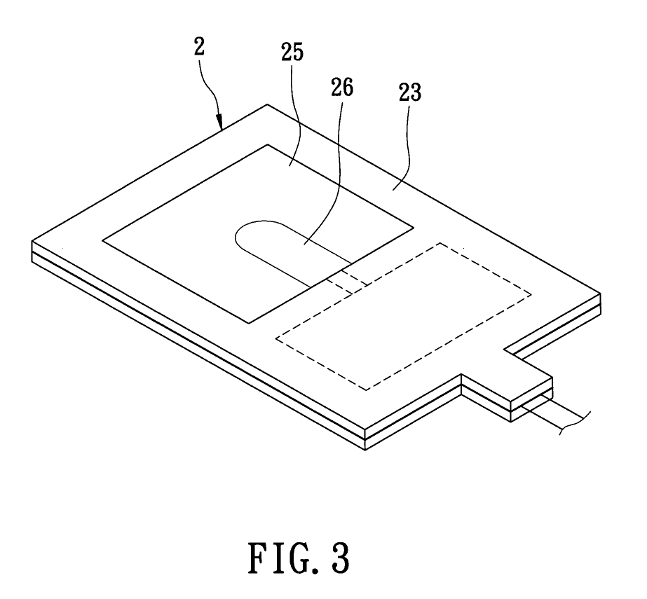

The left and right auxiliary signal lights 2 are adapted to be mounted on the automobile body 34 at a level above the main directional lighting unit. In particular, the left and right auxiliary signal lights 2 are adapted to be mounted respectively on inner surfaces of upper left and right corner portions of the front windshield 33. In this embodiment, the left and right auxiliary signal lights 2 are adapted to be coupled electrically to the directional lighting controller such that the left and right auxiliary signal lights 2 operate in synchronization with the front left and right main signal lights 32 of the main directional lighting unit. Preferably, as best shown in FIG. 2, each of the left and right auxiliary signal lights 2 includes an electroluminescent plate 21 that has a phosphorescent film 212 and a pair of transparent thin films 211, 210 that are disposed respectively on opposite surfaces of the phosphorescent film 212. Alternatively, as best shown in FIG. 3, each of the left and right auxiliary signal lights 2 includes a light emitting diode 26 and a generally rectangular housing 23. The light emitting diode 26 is disposed in the housing 23. The housing 23 is formed with a window 25 that is registered with the light emitting diode 26.

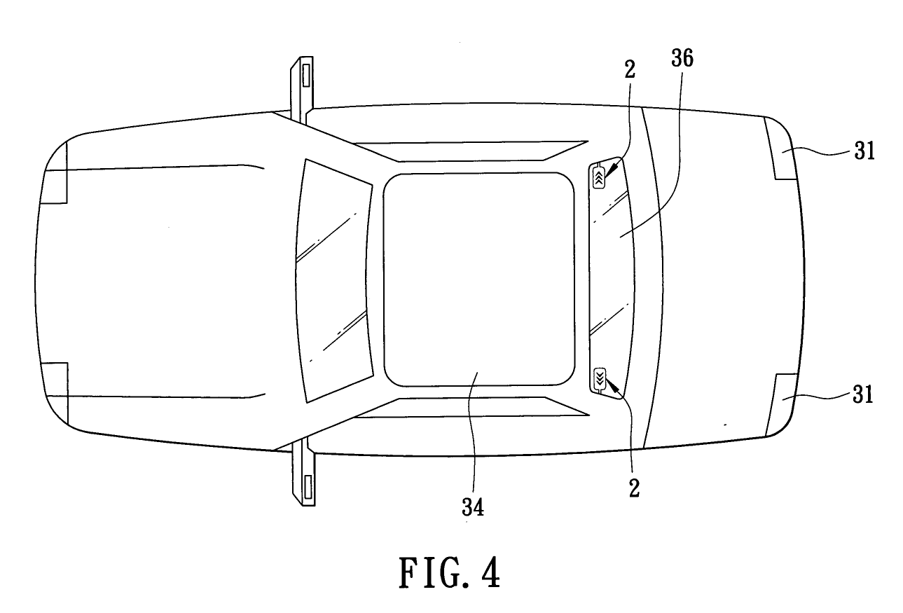

The auxiliary directional light device of this invention should not be limited for mounting on the front windshield 33 of the automobile body 34. As shown in FIG. 4, the left and right auxiliary signal lights 2 may be mounted instead on inner surfaces of upper left and right corner portions of the rear windshield 36 of the automobile body 34, respectively. In this case, the left and right auxiliary signal lights 2 are adapted to be coupled electrically to the directional lighting controller (not shown) such that the left and right auxiliary signal lights 2 operate in synchronization with the rear left and right main signal lights 31 of the main directional lighting unit.

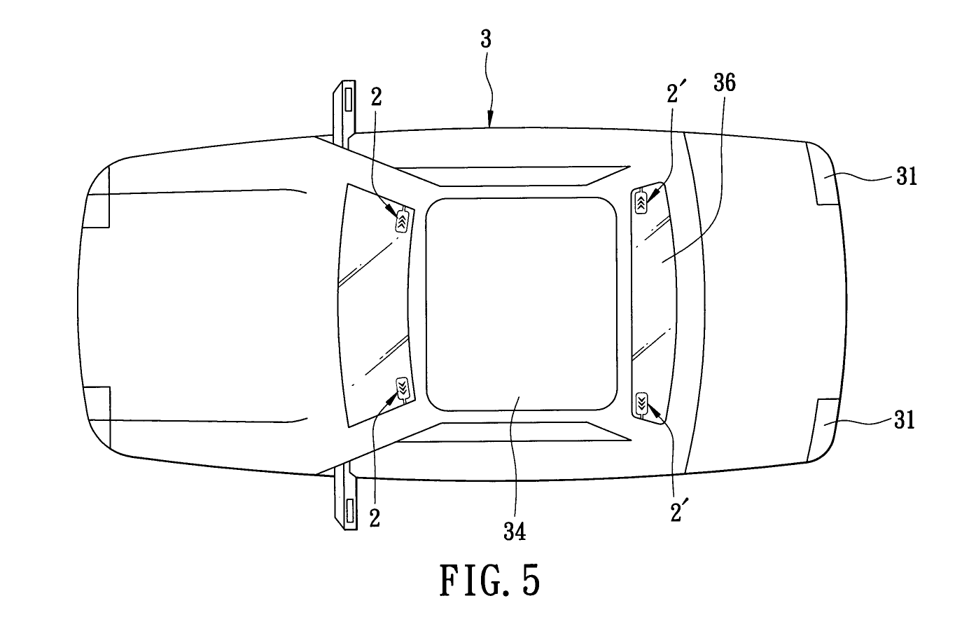

In practice, two pairs of the left and right auxiliary signal lights 2, 2′ may be mounted respectively on upper left and right corner portions of the front and rear windshields 33, 36, as best shown in FIG. 5. In this case, the left and right auxiliary signal lights 2 on the front windshield 33 operate in synchronization with the left and right main signal lights, whereas the left and right auxiliary signal lights 2′ operate in synchronization with the rear left and right main signal lights 31 of the main directional lighting unit.

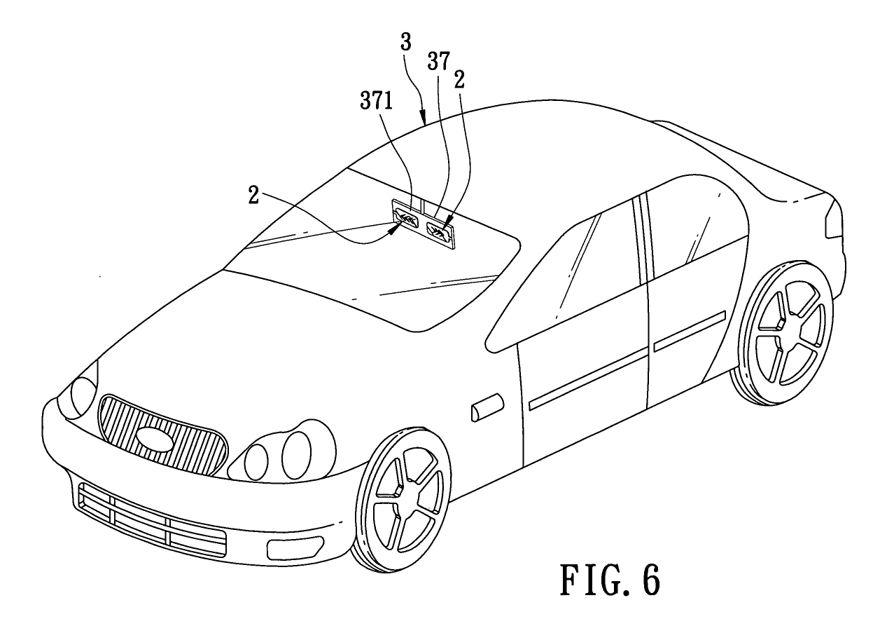

FIG. 6 illustrates the second preferred embodiment of an auxiliary directional light device according to the present invention. When compared with the first preferred embodiment, the automobile 3 further includes a rearview mirror device 37 that has a mirror casing 371 with a rear side. The left and right auxiliary signal lights 2 are mounted respectively on left and right end portions of the rear side of the mirror casing 371 of the rearview mirror device 37.

It has thus been shown that auxiliary directional light device of this invention includes left and right auxiliary signal lights 2 that are mounted higher than the headlights 35. The construction as such prevents light emitted by the left and right auxiliary signal lights 2 from being affected by light emitted by the left and right headlights 35, and from being easily blocked by nearby automobiles, thereby overcoming the aforesaid drawbacks of the prior art.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. An auxiliary directional light device for an automobile having an automobile body mounted with a main directional lighting unit, and a directional lighting controller for controlling operation of the main directional lighting unit, said auxiliary directional light device comprising:
left and right auxiliary signal lights adapted to be mounted on the automobile body at a level above the main directional lighting unit and adapted to be coupled electrically to the directional lighting controller such that said auxiliary signal lights operate in synchronization with the main directional lighting unit.

2. The auxiliary directional light device as claimed in claim 1, wherein said auxiliary signal lights are adapted to be mounted on a windshield of the automobile body.

3. The auxiliary directional light device as claimed in claim 1, wherein each of said auxiliary signal lights includes an electroluminescent plate.

4. The auxiliary directional light device as claimed in claim 1, wherein each of said auxiliary signal lights includes a light emitting diode.

5. An automobile comprising:
an automobile body having a windshield;
a main directional lighting unit mounted on said automobile body;
a directional lighting controller coupled electrically to and controlling operation of said main directional lighting unit; and
an auxiliary directional light device including left and right auxiliary signal lights mounted on upper left and right corner portions of said windshield and coupled electrically to and controlled by said directional lighting controller such that said auxiliary signal lights operate in synchronization with said main directional lighting unit.

6. The automobile as claimed in claim 5, wherein each of said auxiliary signal lights includes an electroluminescent plate.

7. The automobile as claimed in claim 5, wherein each of said auxiliary signal lights includes a light emitting diode.

8. A rearview mirror device for an automobile having an automobile body mounted with a main directional lighting unit, and a directional lighting controller for controlling operation of the main directional lighting unit, said rearview mirror device comprising:
a mirror casing having a rear side; and
an auxiliary directional light device including left and right auxiliary signal lights mounted on said rear side of said mirror casing and adapted to be coupled electrically to the directional lighting controller such that said auxiliary signal lights operate in synchronization with the main directional lighting unit.

9. The rearview mirror device as claimed in claim 8, wherein each of said auxiliary signal lights includes an electroluminescent plate.

10. The rearview mirror device as claimed in claim 8, wherein each of said auxiliary signal lights includes a light emitting diode.
